(19) United States
(12) Patent Application Publication
(10) Pub. No.: US 2003/0232517 A1
(43) Pub. Date: Dec. 18, 2003

(54) Electrical connector assembly

(76) Inventors: Li Qi Liu, Kunshan (CN); Jian Qiang Zhang, Kunshan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/293,540

(22) Filed: Nov. 12, 2002

(30) Foreign Application Priority Data
Jun. 13, 2002 (TW) 091208816

(51) Int. Cl. H01R 12/00

(52) U.S. Cl. 439/67

(57) ABSTRACT

An audio jack assembly (1) includes an audio jack (2) and a flexible printed circuit board (PCB) (3). The audio jack includes an insulative housing (20) and a plurality of contacts received therein. Each contact has a soldering portion (22) extending out of the housing. The flexible PCB includes a plurality of solder pads (32) and a plurality of terminals (36) electrically connected with corresponding solder pads. The soldering portions of the contacts of the audio jack are soldered to corresponding solder pads. The terminals are disposed on an end portion (34) of the flexible PCB and extend rearwardly to be contacted with an interface in an electronic device.

### BACKGROUND OF THE INVENTION

1. Field of the Invention

The present invention relates to an electrical connector assembly, and more particularly to an audio jack assembly with a flexible printed circuit board (PCB).

2. Description of the Prior Art

An audio jack is mounted in an electronic device for transmitting audio signals. A conventional audio jack is, for example, disclosed in U.S. Pat. No. 6,224,408 B1. The audio jack includes a dielectric housing 6, a plurality of terminals 1-5 received in the housing 6, and a plug receptacle 7 formed on the housing 6. Each terminal 1-5 has a soldering portion 102-502 extending out of a bottom portion of the housing 6. In use, the audio jack is disposed at a predetermined position on a printed circuit board (PCB) in an electronic device, with the soldering portions 102-502 of the terminals 1-5 being soldered to corresponding circuit traces on the PCB.

However, the audio jack with such a design requires a relatively complex installation process. In addition, the space in the electronic device for the audio jack is limited, while the configuration of the audio jack is fixed and cannot be adjusted, so it is difficult to employ the same audio jack in different kinds of electronic devices because of configuration mismatches.

Hence, an improved audio jack is required to overcome the disadvantages of the prior art.

### BRIEF SUMMARY OF THE INVENTION

A main object of the present invention is to provide an audio jack assembly which can be conveniently installed in an electronic device.

Another object of the present invention is to provide an audio jack assembly with a flexible printed circuit board (PCB), wherein the configuration and dimension of the flexible PCB can be adjusted to fit a space in the electronic device.

An audio jack assembly according to the present invention comprises an audio jack and a flexible PCB.

The audio jack includes an insulative housing and a plurality of contacts received therein. Each contact has a soldering portion extending out of the housing. The flexible PCB includes a plurality of solder pads and a plurality of terminals electrically connected with corresponding solder pads. The soldering portions of the contacts of the audio jack are soldered to corresponding solder pads. The terminals are disposed on a first surface of an end portion of the flexible PCB and extend rearwardly. A rigid panel is attached to a second surface of the end portion. The end portion and the terminals are inserted into an interface in an electronic device by assistance of the rigid panel.

Other objects, advantages and novel features of the invention will become more apparent from the following detailed description when taken in conjunction with the accompanying drawings.

### BRIEF DESCRIPTION OF THE DRAWINGS

FIG. 1 is an exploded, upside-down view of an audio jack assembly according to the present invention.

FIG. 2 is a right-side up view of FIG. 1.

FIG. 3 is an assembled view of FIG. 1.

FIG. 4 is an assembled view of FIG. 2.

### DETAILED DESCRIPTION OF THE INVENTION

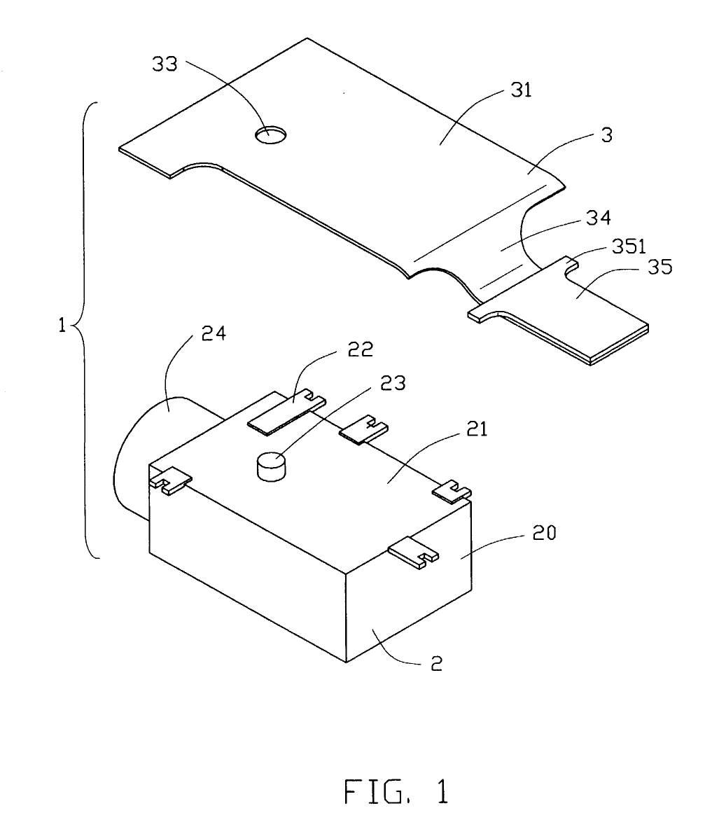

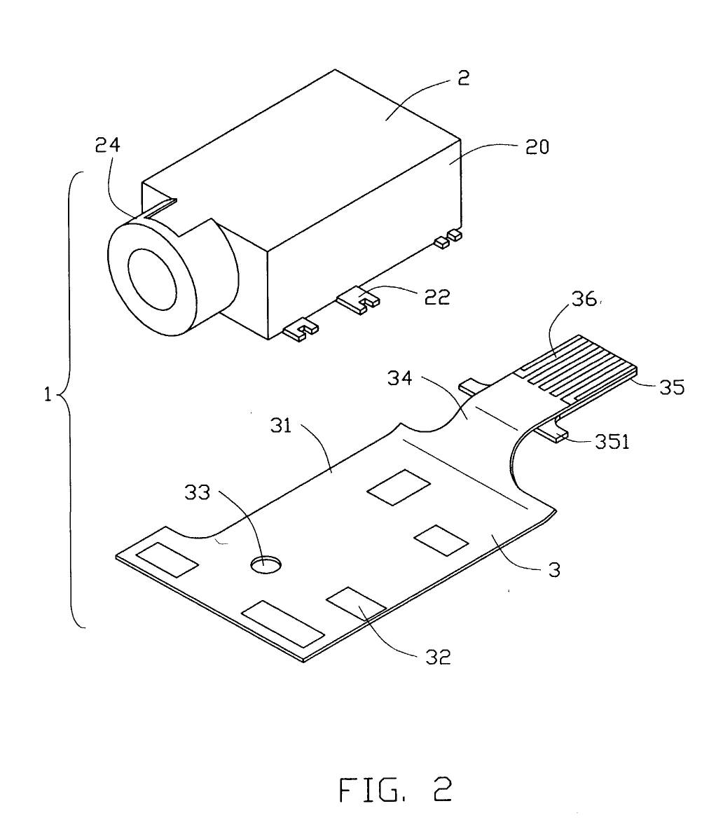

Referring to the drawings and particularly to FIGS. 1 and 2, an audio jack assembly 1 in accordance with the present invention comprises an audio jack 2 and a flexible printed circuit board (PCB) 3.

The audio jack 2 comprises an insulative housing 20 and a plurality of conductive contacts (not labeled) received in the housing 20. Each contact has a soldering portion 22 extending out of the housing 20. A post 23 protrudes downwardly from a bottom surface 21 of the housing 20. A plug receptacle portion 24 protrudes forwardly from a front surface (not labeled) of the housing 2. The audio jack 2 has a configuration similar to that of a conventional audio jack, for example, the audio jack as disclosed in U.S. Pat. No. 6,224,408 B1. Therefore, detailed internal structure of the audio jack 2, which can be found by referring to the prior art, is omitted herein.

The flexible PCB 3 comprises a substantially rectangular base portion 31, an end portion 34 extending rearwardly from a rear edge of the base portion 31, and a rigid panel 35 attached to a bottom surface of the end portion 34. A pair of holding portions 351 protrudes laterally from two opposite edges of the rigid panel 35. A hole 33 is defined in the base portion 31, corresponding to the post 23 of the audio jack 2. A plurality of solder pads 32 are formed on a top surface of the base portion 31, corresponding to the soldering portions 22 of the contacts of the audio jack 2. A plurality of metal terminals 36 are formed on a top surface of the end portion 34. Each terminal 36 is electrically connected with a corresponding solder pad 32 by a circuit trace (not shown) in the flexible PCB 3.

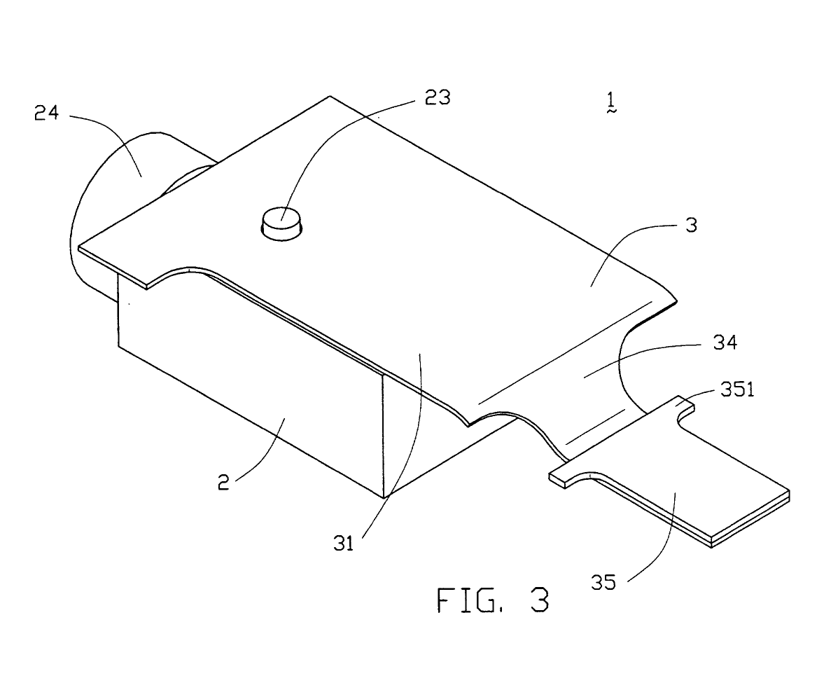

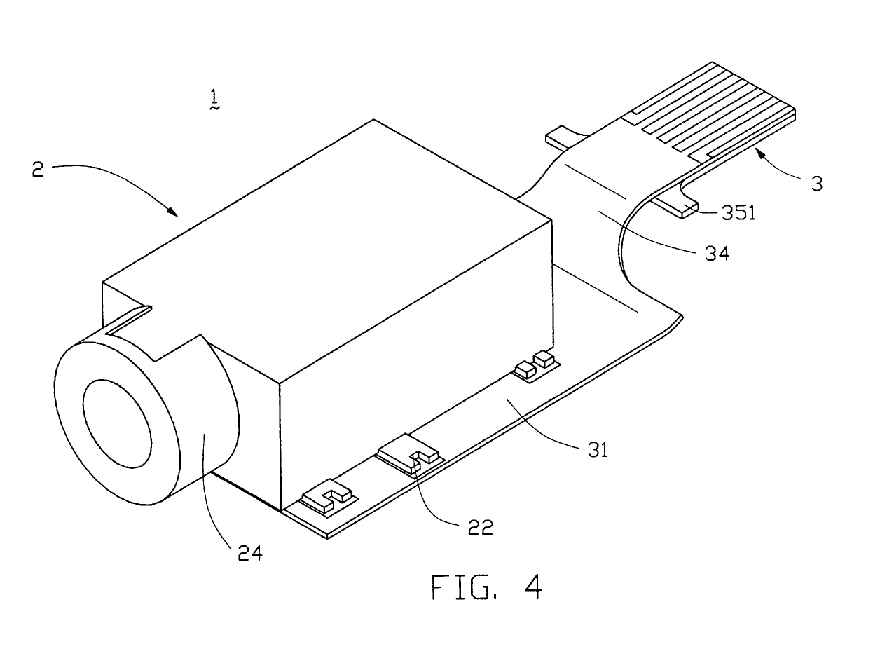

Referring to FIGS. 3 and 4, in assembly, the audio jack 2 is mounted onto the flexible PCB 3, with the bottom surface 21 resting on the top surface of the base portion 31, the post 23 being inserted into the hole 33 and the soldering portions 22 of the contacts being soldered to the corresponding solder pads 32.

During the installation process, the audio jack assembly 1 can be connected in an installation space of an electronic device (not shown) without needing a further soldering process. An assembler can hold the holding portions 351 to insert the rigid panel 35 together with the end portion 34 into an interface of another PCB of the electronic device. The electrical connection between the audio jack 2 and the PCB is achieved by the terminals 36 electrically connecting with the interface.

The circuit traces and the terminals 36 can be redesigned to provide a desired audio channel configuration, such as for stereo or mono-channel. The configuration and dimensions of the flexible PCB 3 can be adjusted to match the installation space of the electronic device in which it is installed. The whole audio jack assembly 1 can also be conveniently replaced, since the audio jack assembly 1 can be removed simply by pulling the rigid panel 35 together with the end portion 34 from the interface of the electronic device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly adapted to electrically connect with an interface of a printed circuit board (PCB) of an electronic device, comprising:
a flexible PCB comprising a base portion, an end portion extending from the base portion for connecting with the interface of the PCB in the electronic device, a plurality of solder pads disposed on the base portion, and a plurality of terminals disposed on the end portion and electrically connected with corresponding solder pads; and
an electrical connector mounted on the base portion of the flexible PCB, the electrical connector having an insulative housing and a plurality of conductive contacts received in the housing, each contact corresponding to a solder pads of the flexible PCB, each contact having a soldering portion extending out of the housing and soldered to the corresponding solder pad.

2. The electrical connector assembly as claimed in claim 1, wherein the electrical connector is an audio jack, and the insulative housing comprises a plug receptacle portion protruding forwardly from a front surface thereof and a post protruding downwardly from a bottom surface thereof.

3. The electrical connector assembly as claimed in claim 2, wherein the flexible PCB defines a hole for engaging with the post of the housing.

4. The electrical connector assembly as claimed in claim 2, wherein the end portion of the flexible PCB extends rearwardly from the base portion.

5. The electrical connector assembly as claimed in claim 1, wherein the flexible PCB comprises a rigid panel attached to the end portion on a face opposite to that on which the terminals are attached for facilitating insertion of the end portion into the interface of the PCB in the electronic device.

6. The electrical connector assembly as claimed in claim 5, wherein the rigid panel has a pair of holding portions protruding laterally from two opposite sides thereof for facilitating handling.

7. An electrical connector assembly adapted to electrically connect with an interface of a printed circuit board (PCB) of an electronic device, comprising:
a flexible PCB; and
an electrical connector disposed on the flexible PCB, the electrical connector having an insulative housing and a plurality of conductive contacts received in the housing and electrically connecting to the flexible PCB.

8. The electrical connector assembly as claimed in claim 7, wherein the flexible PCB comprises a base portion and an end portion extending from the base portion for electrically connecting with the interface of the PCB in the electronic device.

9. The electrical connector assembly as claimed in claim 8, wherein the base portion has a plurality of solder pads disposed on a top surface thereof, and the end portion has a plurality of terminals disposed thereon and electrically connected with corresponding solder pads.

10. The electrical connector assembly as claimed in claim 9, wherein the flexible PCB comprises a rigid panel attached to the end portion on a face opposite to that on which the terminals are attached for facilitating insertion of the end portion into the interface of the PCB in the electronic device.

11. The electrical connector assembly as claimed in claim 10, wherein the rigid panel has a pair of holding portions protruding laterally from two opposite sides thereof for facilitating handling.

12. The electrical connector assembly as claimed in claim 9, wherein the contacts of the electrical connector extend out of the housing to solder to corresponding solder tabs of the flexible PCB.

13. An electronic device comprising:
an internal solid printed circuit board; and
a removable/repairable jack assembly comprising:
a connection jack fixedly installed in a small interior of the device with an open mating port exposed to an exterior, said connection jack being not directly secured to said solid printed circuit board; and
a flexible printed circuit board flexibly extending in said small interior and defining two ends of which, one is mechanically and electrically connected to mechanical portions and electrical portions of said jack, and the other is mechanically and electrically connected to said solid printed circuit board.

14. The electrical device as claimed in claim 13, wherein said mechanical portions includes a post, and said electrical portions include a plurality of contacts.

15. The electrical device as claimed in claim 14, wherein said one end defines a through hole and a plurality of solder pads to respectively mate said post and said plurality of contacts.

16. The electrical device as claimed in claim 13, wherein said the other end defines a plurality of terminals removeably mated with an interface of said solid printed circuit board.

17. The electrical device as claimed in claim 16, wherein said terminals are not soldered on the interface.
